(19) United States
(12) Patent Application Publication
(10) Pub. No.: US 2008/0023287 A1
(43) Pub. Date: Jan. 31, 2008

(54) Drive arrangement for a hybrid vehicle

(75) Inventors: Andreas Thiede, Gochsheim (DE); Udo Niehaus, Schonungen (DE); Thorsten Muller, Friedrichshafen (DE); Alexander Bartha, Wuzburg (DE); Michael Wetzel, Schwanfeld (DE); Christoph Sasse, Schweinfurt (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG, Friedrichshafen (DE)

(21) Appl. No.: 11/880,071

(22) Filed: Jul. 18, 2007

(30) Foreign Application Priority Data
Jul. 28, 2006 (DE) 10 2006 034 945.8

(51) Int. Cl. B60K 6/387

(52) U.S. Cl. 192/48.1

(57) ABSTRACT

A drive arrangement for a hybrid vehicle includes an internal combustion engine with a takeoff shaft; an electrical machine with a rotor and a stator; a first and a second clutch, each with an input part and an output part; and a housing, which surrounds at least the clutches and the electrical machine. The input part of the first clutch is in working connection with the takeoff shaft of the internal combustion engine, and the output part of the second clutch can be connected to the drive wheels of the vehicle. A torque-transmitting device for transmitting a torque is installed between the output part of the first clutch and the input part of the second clutch, where the housing has an intermediate housing wall, on which the rotor of the electrical machine is at least indirectly supported, and where the rotor of the electrical machine is or can be connected nonrotatably to the torque-transmitting device.

### BACKGROUND OF THE INVENTION

### Field of the Invention

The invention pertains to a drive arrangement for a hybrid vehicle, especially for a full hybrid, which can be driven either solely by the electric motor or solely by the internal combustion engine or by both in a mixed operating mode.

### SUMMARY OF THE INVENTION

An object of the invention is to make available an easy-to-install drive arrangement for a hybrid vehicle of the type indicated above.

According to the invention, the drive arrangement includes a first clutch having an input part and an output part, wherein the input part can be connected to the takeoff shaft of an internal combustion engine; a second clutch having an input part and an output part, wherein the output part can be connected to the drive wheels of the vehicle; and a torque transmitting device installed between the output part of the first clutch and the input part of the second clutch. An electrical machine having a rotor and a stator is provided, wherein the rotor can be connected nonrotatably to the torque transmitting device. A housing surrounds the first clutch, the second clutch, and the electrical machine, wherein the housing has an intermediate wall on which the rotor is supported. When the inventive drive arrangement is to be installed, it is very easy to form and to assemble the individual modules. The electrical machine is a preassembled structural unit, in which the rotor and stator are already positioned with respect to each other, and it can thus be integrated into the drive arrangement easily and without complicated positioning.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows an inventive drive arrangement for a hybrid vehicle with a second clutch designed as a hydrodynamic torque converter. To create a torque-transmitting device, the converter “hub” of the torque converter is extended to serve as an intermediate shaft, which cooperates with the output part of a first clutch downline from the internal combustion engine and with the rotor of an electrical machine, where a hydraulic actuating cylinder for the first clutch, the cylinder of which is permanently attached to the housing, is designed as a bearing seat for the rotor of the electrical machine;

FIG. 2 shows a drive arrangement similar to FIG. 1, where a flange, permanently attached to the housing, is provided as a bearing seat for the rotor of the electrical machine;

FIG. 3 shows a drive arrangement similar to FIG. 1, where, in contrast to FIG. 1, the intermediate shaft consists of two parts;

FIG. 4 shows a drive arrangement similar to FIG. 1, where a rotor hub of the electrical machine is designed as the intermediate shaft;

FIG. 5 shows a drive arrangement similar to FIG. 1, where the converter hub is designed as a part separate from the intermediate shaft and is supported therein, and where the rotor hub is connected nonrotatably to the input part of the hydrodynamic converter;

FIG. 6 shows a drive similar according to FIG. 1, where the seat which supports the rotor hub is formed directly by a tubular section of the intermediate housing wall, and where the intermediate shaft is divided inside the rotor hub; and

FIG. 7 shows a drive arrangement according to FIG. 6, where the rotor hub is designed as an intermediate shaft and holds the converter hub for rotation in common.

### DETAILED DESCRIPTION OF THE PRESENTLY PREFERRED EMBODIMENTS

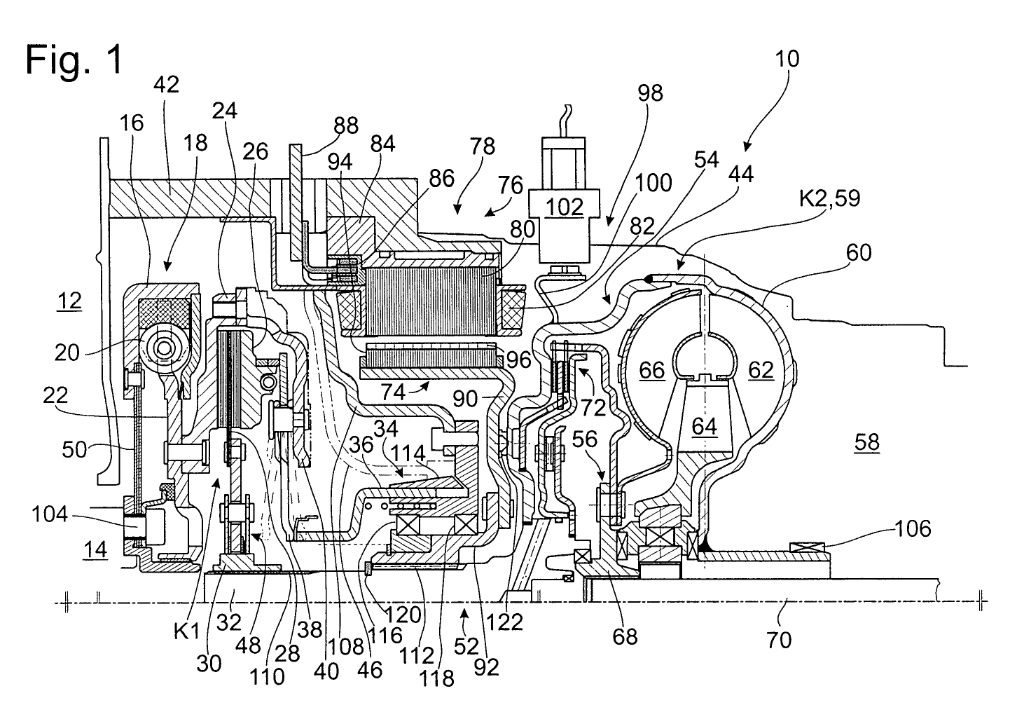

Except for certain details described further below, FIGS. 1-7 show drive arrangements 10 with the same basic structure. This structure includes, as a first drive source, an internal combustion engine 12 with a takeoff shaft designed as a crankshaft 14, the torque of which is introduced to a input part 16, permanently connected to the shaft, of a torsional vibration damper 18, especially a dual-mass flywheel. The torque passes on from there by way of spring type energy-storage devices 20 to an output part 22 of the torsional vibration damper, which forms or contains simultaneously the input part 24, designed as an driven plate, of a shiftable separating clutch K1. The structure of this clutch K1 with a spring-loaded, axially displaceable pressure plate 26 and a clutch disk 28, located between the driven plate 24 and the pressure plate 26, is designed according to the state of the art, where the clutch disk conducts the torque by means of a toothed clutch hub 30 to an output shaft 32. In the present case, the clutch K1 is designed as a dry friction clutch of the “push” type and is actuated by means of an actuating device 34. In the examples, the actuating device is designed as a concentric slave cylinder and is arranged around the clutch output shaft 32, where the piston 36 of the slave cylinder 34 can act on an actuating element 38 of the clutch K1. The actuating element 38 of the clutch K1 is formed by a conventional diaphragm spring, which is supported pivotably on a housing 40 of the clutch K1. The slave cylinder is driven by a way of a fluid line 46, which is connected to the cylinder and which is preferably introduced from the outside. The line passes through an intermediate housing 42 or the transmission bell 44 and is designed to be connected to a hydraulic master cylinder (not shown).

In the flow of torque between the clutch disk 28 and the clutch hub 30, a first-stage damper 48 is provided, but its task here is not primarily to reduce or to damp the transmission of torsional vibrations to the output shaft 32 but rather to compensate for any static axial offset which may be present between the crankshaft 14 and the output shaft 32. The wobbling movements introduced by the crankshaft 14 into the drive arrangement 10 are compensated by an element 50 in the dual-mass flywheel 18, this element being capable of absorbing the wobbling movements.

The torque introduced from the internal combustion engine 12 arrives next by way of a torque-transmitting device 52, to be described in greater detail further below, at the input part 54 of a second clutch K2 and from there proceeds to the output part of this clutch. From there it passes onward to a gear-shift transmission 58 and finally arrives at the drive wheels of the vehicle. In the present case, a hydrodynamic clutch, especially a hydrodynamic torque converter 59, serves as the second clutch K2. This clutch has a pump wheel 62 as the input part, connected to the clutch housing 60; a stator 64; and a turbine wheel 66, serving as the output part, which, by way of a hub 68 with a set of teeth is connected to the input shaft 70 of a gear-shift transmission 58, especially of an automatic transmission. The torque converter also contains a conventional bridging clutch 72, by means of which a direct mechanical connection for rotation in common, bypassing the hydrodynamic circuit, can be established between the input part 54 and the output part 56 of the torque converter 59. The fluid is supplied by a fluid circuit and is set into forced flow by the action of a pump, driven by the pump wheel 62.

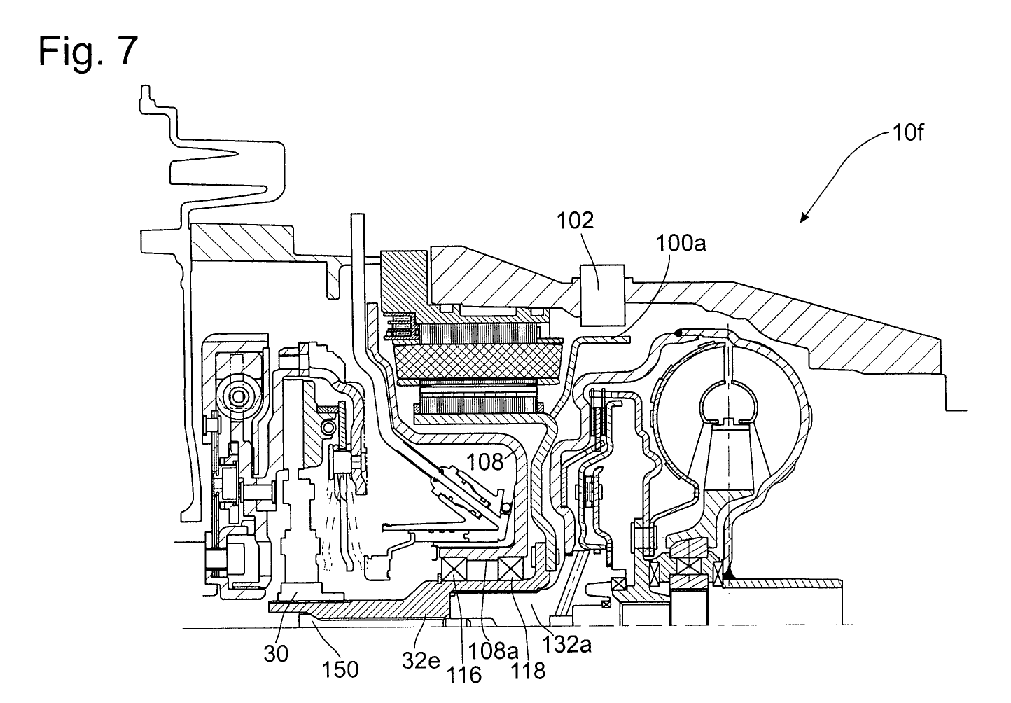

The rotor 74 of an electrical machine 76, furthermore, is connected nonrotatably to the output shaft 32 of the clutch K1, i.e., to the torque-transmitting device 52. The particular design of the electrical machine is of no importance in the context of the present invention. In the present examples, it is a synchronous machine of the internal rotor type, excited by permanent magnets. The stator 78 of the machine carries a laminated core 80 and a winding 82 and is attached by means of a stator carrier 84 to an intermediate housing 42 located axially between the internal combustion engine 12 and the gear-shift transmission 58 or directly to a housing 44 of the gear-shift transmission 58. The winding 82 comprises a plurality of individual coils, mounted on stator teeth. The ends of the coils are wired together in a predetermined manner by means of a common connection device 86 with several linking conductors, the linking conductors having terminals 88, which lead outside the housing 42 for connection to a source of electrical energy. The rotor 74 of the electrical machine 76 includes a rotor carrier 90 with a separate or integral rotor hub 92, a laminated core 94 mounted on the carrier 90, and permanent magnets 96 mounted on or in the area of the outer circumferential surface of the laminated core 94, the magnetic field of the magnets thus being able to interact in the known manner with the magnetic field of the stator winding 82. The electrical machine 76 is controlled, that is, the stator 78 is supplied with three-phase current, as a function of the position of the rotor 74 with respect to the coil winding of the stator. To detect the relative angle of rotation between the rotor 74 and the stator 78, the electrical machine 76 has a rotational position sensor system 98 with a sensor ring 100 mounted nonrotatably with respect to the rotor 74. The ring has a contour track, which varies periodically in the circumferential direction. As shown in FIGS. 1-5, the ring with the track is mounted on the housing 60 of the hydrodynamic torque converter 59, the housing being connected nonrotatably to the rotor 74. The track is scanned by an inductive sensor 102 to obtain the rotational position information. In contrast, FIG. 7 shows the sensor ring 100a mounted directly on the rotor 74. The rotational position data are transmitted to an electronic control circuit of the electrical machine 76, which derives from them the times at which the stator winding 82 is to be supplied with current.

To install the drive arrangement 10, a first module is formed by attaching the torsional vibration damper 18 together with the first clutch K1 by means of studs 104 to the crankshaft 14 of the internal combustion engine 12. To form a second module, the second clutch K2, that is, the hydrodynamic torque converter 59 in the present case, is pushed onto the input shaft 70 of the gear-shift transmission 58, where the hub 68 enters into a connection for rotation in common with the input shaft 70, and where a radial bearing supports the second clutch K2 on one side against the gear-shift transmission 58.

The electrical machine 76 is preassembled as a separate unit. According to a first installation variant, the rotor 74 and the stator 78 are mounted on an intermediate housing 42 surrounding the electrical machine 76 so that they are properly aligned with each other. The actuating device 34 for actuating the first clutch K1 is either already in place or is put in place now. This unit is attached to the second module by screwing the intermediate housing 42 to the housing 44 of the gear-shift transmission 58. Depending on how the torque-transmitting device 52 is designed, the connection for rotation in common between the rotor 74 and the input part 54 of the second clutch is also made at this point.

If, however, a separate intermediate housing surrounding the electrical machine 76 is not provided and instead the electrical machine 76 is to be installed inside an appropriately lengthened gearbox housing 44, then, according to a second installation variant, the electrical machine 76 with its stator 78 and its rotor 74 is attached to a separate intermediate housing wall 108, which is then screwed to the second module, that is, to the gearbox housing 44, or to the first module, i.e., the housing of the internal combustion engine 12.

After the two modules have been installed, they are connected to form the drive arrangement 10, where the torque-transmitting device 52 comprising the output shaft 32 is introduced into the clutch hub 30 of the clutch K1, and the actuating element 38 of the clutch K1 arrives in contact with the actuating device 34, more precisely, with the piston 36 of the slave cylinder 34, and where the intermediate housing 42 or the housing 44 of the automatic transmission 58 is connected to the housing of the internal combustion engine 12.

A hybrid vehicle equipped with a drive arrangement 10 of this type represents a so-called “full hybrid”. When the clutch K1 is open, a drive torque generated by the electrical machine 76 can be introduced via the machine's rotor 74 to the torque converter 59 and then to the gearbox 58, from which it is sent to the drive wheels of the vehicle. The vehicle can thus be operated without producing any emissions, as is preferred and/or necessary over short distances and/or in congested areas. It is also possible, in the reverse manner, to introduce a drive torque from the drive wheels to the rotor 74 of the electrical machine 76 in “drag operating mode” and thus to brake electrically in recuperation mode and to feed electrical energy to an energy storage device, which advantageously is done while the bridging clutch 72 of the hydrodynamic torque converter 59 is closed. From this state, it is possible, with either a stopped or moving vehicle, to close the clutch K1 and to start the internal combustion engine 12 through the kinetic energy of the moving vehicle and/or through the motor action of the electrical machine 76 alone. The engine can then work in combination with the electrical machine 76 or can drive the vehicle by itself. According to this strategy, the clutch K1 is used only as a starter clutch for starting the internal combustion engine 12. Only the hydrodynamic clutch K2 is actually used to move the vehicle off. As a result, the clutch K1 can be smaller than that used in a vehicle driven only by an internal combustion engine. Even in the case of operation solely by the power of an internal combustion engine or a mixed drive, recuperation mode with the electrical machine 76 is still possible.

Even when the vehicle is operating solely by the power of the internal combustion engine, the electrical machine 76 can still work as a generator to supply the on-board electrical system with energy.

The special features of the drive arrangement 10 illustrated in FIGS. 1-7 are discussed in the following.

FIG. 1 shows that the input part 54 of the second clutch K2, that is, the torque converter 59 in the present case, includes an intermediate shaft 32 extending all the way to the clutch K1 instead of a conventional short pin. This intermediate shaft has a first toothed area 110, by which it can accept nonrotatably the hub 30 of the first clutch K1, and a second toothed area 112, located axially between the first area and the housing 60 of the torque converter 59, by which it can accept a toothed rotor hub 92, which is connected nonrotatably to the rotor carrier 90 and to the rotor 74 of the electrical machine 76. Thus the output shaft of the first clutch K1 serves simultaneously as the intermediate shaft. In other words, the torque-transmitting means are formed on the clutch K2.

The intermediate housing wall 108 is located axially in the area of the electrical machine 76. It starts from a radially outer position and proceeds essentially in a radially inward direction, and it occupies a position axially between the gearbox housing 44 and the intermediate housing 42, being fastened to at least one of these parts 42, 44. The internal rotor 74 of the electrical machine 76 has the shape of a cup with a cavity. The part of the intermediate housing wall 108 located radially inside the rotor 74 projects into this cavity, where it is screwed or riveted to the housing 114 of the hydraulic slave cylinder 34 and thus carries the cylinder 34. The inner circumferential surface of the housing 114 of the slave cylinder 34 also provides two bearing points for radial bearings 116, 118, especially roller bearings, which in turn support the rotor hub 92 and the intermediate shaft 32, i.e., the torque-transmitting means 52. This support arrangement offers the advantage that both the stator 78 and the rotor 74 are supported rigidly on the housing and can be positioned securely with respect to each other. The support forces acting on the slave cylinder 34 upon actuation of the clutch K1 are absorbed by the intermediate housing wall 108, so that the radial bearings 116, 118 are essentially free of axial forces.

On the side of the torque converter 59 axially opposite the electrical machine 76, the converter is supported in the conventional manner on the gear-shift transmission 58 by way of the bearing 106, which is mounted permanently on the housing. For the axial fixation of the torque converter 59, two stops 120, 122 are formed axially in the area of the electrical machine 76. A first stop 120 is formed by a locking ring 120, which comes to rest against the rotor hub 92, whereas a second stop 122 is formed on a radial housing section of the torque converter 59, where it can come to rest against a section of the rotor carrier 90 parallel to the previously mentioned converter housing section.

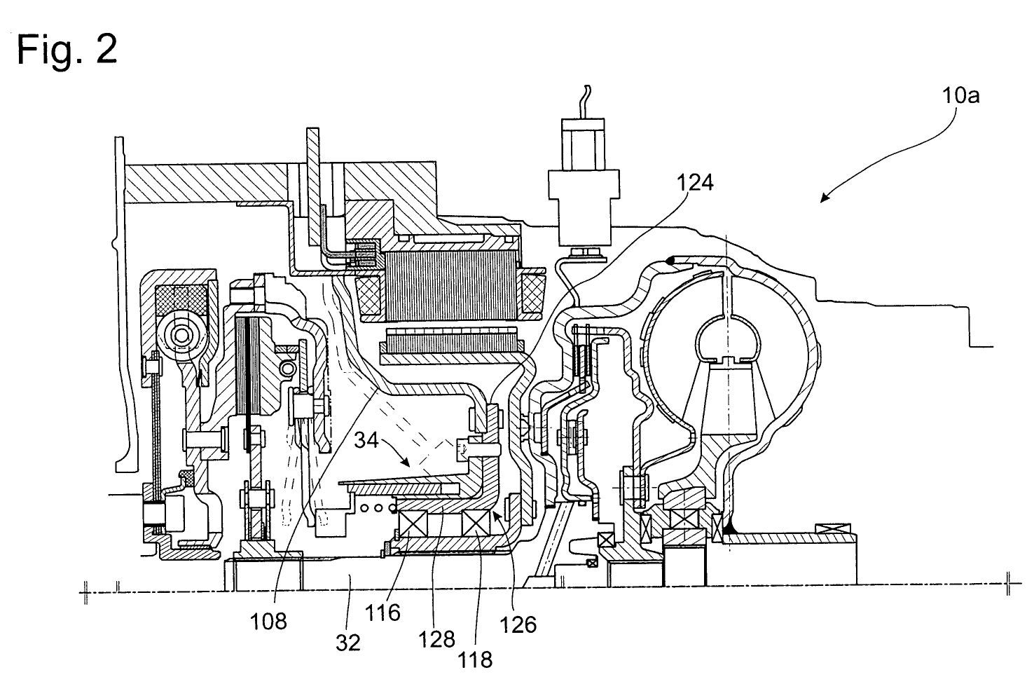

The drive arrangement 10a shown in FIG. 2 is identical to that of FIG. 1 except for the area of the rotor support. It can be seen that the radially inner part of the intermediate housing wall 108 is connected to a radial section 124 of a separate bearing flange 126. This flange comprises also a tubular section 128, on the inner circumferential surface of which the radial bearings 116, 118 are mounted. The concentric slave cylinder 34 is pushed onto the external circumferential surface of this tubular section and attached to the radial section 124. This configuration offers the advantage that, during the installation of the transmission-side module, the slave cylinder 34 can be mounted on the bearing flange 126 as the final step and can thus be replaced more easily when service is required.

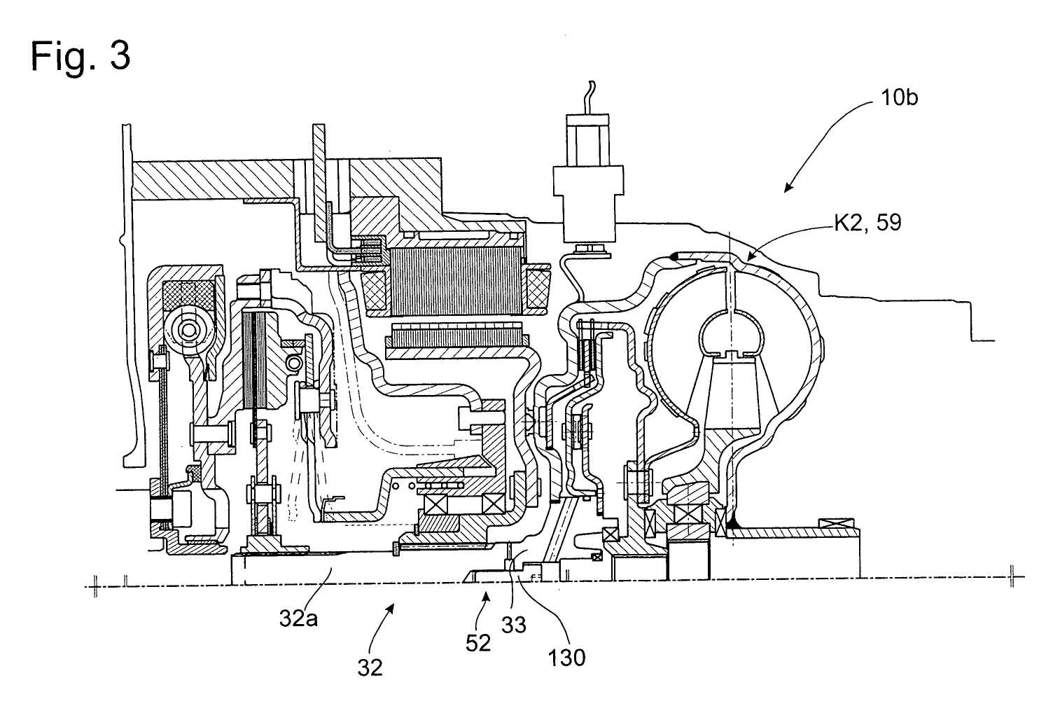

FIG. 3 shows a drive arrangement 10b, which is identical to that of FIG. 1 except for the design of the torque-transmitting device 52. Whereas, in FIG. 1, the intermediate shaft 32 is designed as a one-piece part, the intermediate shaft 32 or torque-transmitting device 52 in FIG. 3 consists of two parts 32a, 33, each of which has a set of radial teeth. The parts are assembled axially by means of a stud 130 introduced centrally through the torque converter 59 from the gearbox side.

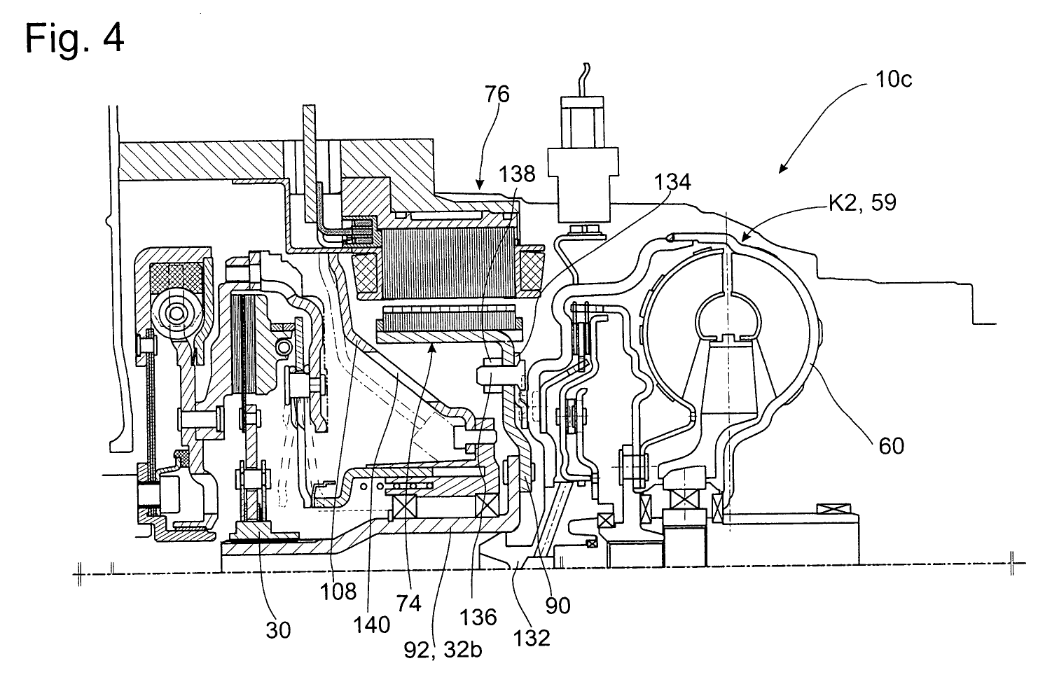

Another embodiment of a drive arrangement 10c based on FIG. 1 is shown in FIG. 4, where, in contrast to FIG. 1, the torque converter 59 has a conventional, i.e., relatively short, converter hub 132 and a connecting plate 134 riveted to the housing 60. The plate carries a plurality of pressed-in stud bolts 136. These stud bolts 136 can project through openings in the rotor 74 of the electrical machine 76, where they are connected inside the receiving space to threaded nuts 138 and in this way secure the rotor 74 to the converter housing 60 for rotation in common and also hold the torque converter 59 in the proper axial position. To allow this assembly step to take place, the intermediate housing wall 108 has one or more access openings 140.

It can also be seen that the rotor hub 92 in this example is again connected to the rotor carrier 90 and is extended axially so that the clutch hub 30 can be mounted nonrotatably on it. This hub extension is preferably designed as a hollow shaft and thus takes over the function of the intermediate shaft 32 in FIG. 1. The converter hub 132 fits axially into the hollow shaft 92 in the area of the rotor carrier 90, where it can be supported radially.

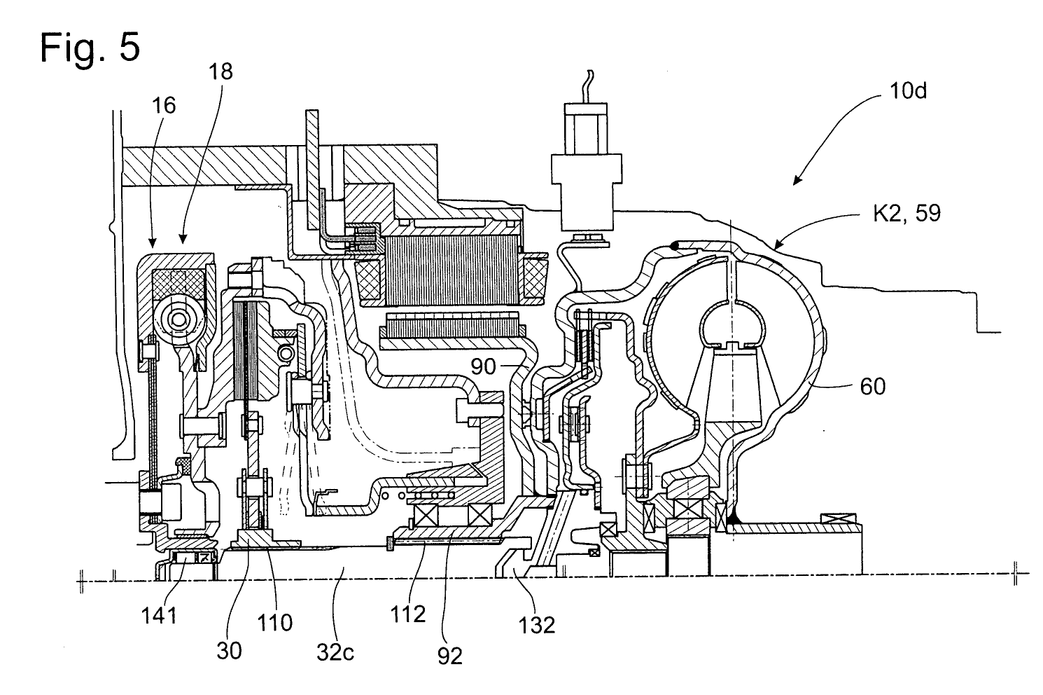

In the case of the drive arrangement 10d according to FIG. 5, based again on FIG. 1, the rotor hub 92 is connected not only to rotor carrier 90 but also to the housing 60 of the torque converter 59 by means of an axial extension. In the present case, both connections are executed as welds. From a comparison with FIG. 1, it can also be seen that the intermediate shaft 32c is designed as a part which is separate from the torque converter 59 and is connected nonrotatably to the clutch hub 30 and to the rotor hub 92 by means of sets of teeth 110, 112. The intermediate shaft is thus also supported inside the rotor hub. Another support for this separate intermediate shaft 32c is provided by a pilot bearing 141, installed inside the input part of the torsional vibration damper 18. It can also be seen that the torque converter is centered inside the intermediate shaft 32c by the converter hub 132.

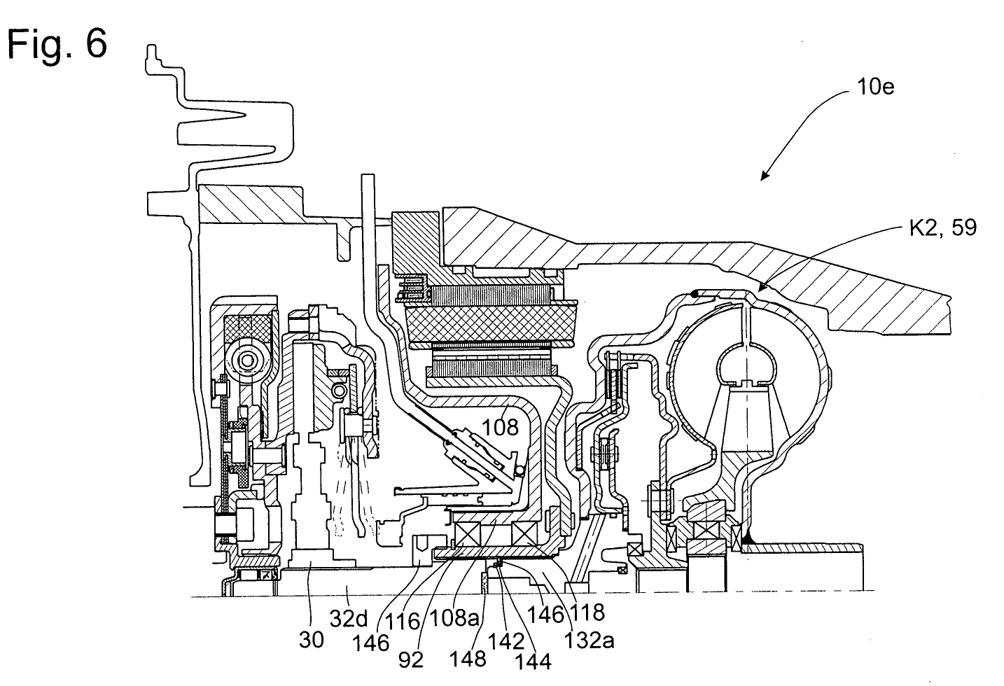

FIG. 6 shows yet another drive train arrangement 10e, which is again identical in its basic structure to the previously described examples and which in particular corresponds to FIG. 5 with respect to the support of the intermediate shaft 32d. In contrast, however, the converter hub 132a in FIG. 6 is extended and provided with a set of external teeth so that it can engage with the internally toothed rotor hub 92. For axial fixation of the free end of the converter hub 132a, an arrangement consisting of two retaining rings 142, 144 is used. The first ring 144 is mounted in a groove inside the rotor hub 92 and thus comes to rest against a ring-shaped shoulder 146 provided on the converter hub 132a. After the rotor hub 92 has been placed on the converter hub 132a, a second retaining ring 142 is inserted into a groove formed in the hub, so that, as can be seen in FIG. 6, the retaining rings 142, 144 are axially adjacent to each other. Another difference versus the examples of FIGS. 1-5 is that the bearing seat of the radial bearings 116, 118 is formed directly by a tubular section 108a of the intermediate housing wall 108.

As a result of manufacturing and installation tolerances, the converter hub 132 has a small amount of axial play with respect to the intermediate shaft 32. To avoid this play, it is advantageous for the intermediate shaft 32d to be clamped axially to the converter hub 132a by means of a clamping device 146, e.g., a straining screw, where a friction disk 148 inserted between the intermediate shaft 23d and the converter hub 132d serves as an axial stop.

In a last exemplary embodiment of a drive arrangement 10f according to FIG. 7, the rotor hub 92 is designed as a hollow intermediate shaft 32e and is extended axially to engage in the clutch hub 30, as already seen in FIG. 4. Furthermore, as already described on the basis of FIG. 6, the extended converter hub 132a is provided with a set of external teeth to engage with the rotor hub 32e. The special feature here is that the connection between the intermediate shaft 32 or rotor hub and the converter hub 132a is accomplished by means of a stud 150, introduced centrally from the side of the clutch K1. Here, too, as already seen in FIG. 6, the bearing seat of the radial bearings 116, 118 is formed directly by a tubular section 108a of the intermediate housing wall 108.

In yet other embodiments (not shown) of the drive arrangements illustrated in FIGS. 1-7, it is also possible for the rotor of the electrical machine to be engaged with and disengaged from the torque-transmitting device by another clutch and its associated actuating device.

It is explicitly pointed out that the term “housing” or “permanently attached to the housing” refers to all housings pertaining to the drive arrangements explained above, e.g., the housing of the internal combustion engine, the housing of the gear-shift transmission, and the intermediate housing or the intermediate housing wall.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A drive arrangement for a hybrid vehicle, the arrangement comprising:
a first clutch having an input part and an output part, wherein the input part can be connected to the takeoff shaft of an internal combustion engine;
a second clutch having an input part and an output part, wherein the output part can be connected to the drive wheels of the vehicle;
a torque transmitting device installed between the output part of the first clutch and the input part of the second clutch;
an electrical machine having a rotor and a stator, wherein the rotor can be connected nonrotatably to the torque transmitting device; and
a housing surrounding the first clutch, the second clutch, and the electrical machine, the housing having an intermediate wall on which the rotor is supported.

2. The drive arrangement of claim 1 wherein the first clutch is a dry friction clutch.

3. The drive arrangement of claim 1 further comprising an actuating device which can actuate the first clutch, the actuating device being supported on the intermediate housing wall.

4. The drive arrangement of claim 3 wherein the actuating device comprises a concentric slave cylinder which supports the rotor of the electrical machine.

5. The drive arrangement of claim 1 wherein the second clutch is a hydrodynamic clutch.

6. The drive arrangement of claim 5 wherein the hydrodynamic clutch is a torque converter.

7. The drive arrangement of claim 1 wherein the torque transmitting device comprises an intermediate shaft which is detachably connected for rotation in common to the output part of the first clutch.

8. The drive arrangement of claim 7 wherein the intermediate shaft is formed as part of the input part of the second clutch.

9. The drive arrangement of claim 7 wherein the intermediate shaft is separate from the second clutch and is in working nonrotatable connection with the input part of the second clutch.

10. The drive arrangement of claim 7 wherein the electrical machine further comprises a rotor hub, the intermediate shaft being in working connection with the rotor hub.

11. The drive arrangement of claim 7 wherein the electrical machine further comprises a rotor hub formed by the intermediate shaft.

12. The drive arrangement of claim 1 wherein the second clutch is supported permanently in the housing.

13. The drive arrangement of claim 1 further comprising a gear shift transmission connected to the output part of the second clutch.

14. The drive arrangement of claim 13 further comprising a torsional vibration damper between the takeoff shaft of the internal combustion engine and the gear shift transmission, the torsional vibration damper having an input part and an output part.

15. The drive arrangement of claim 14 wherein the output part of the torsional vibration damper forms the input part of the first clutch.

16. The drive arrangement of claim 14 wherein the output part of the torsional vibration damper is nonrotatably connected to the input part of the first clutch.
